(19) United States
(12) Patent Application Publication
(10) Pub. No.: US 2025/0284759 A1
(43) Pub. Date: Sep. 11, 2025

(54) REPRESENTATIVE SCENARIO GENERATOR AIDED BY CHARACTERISTICS CLUSTERING

(71) Applicant: Dell Products L.P., Round Rock, TX (US)

(72) Inventors: Marcus Vinicius Libardi Pazini, Caxias do Sul (BR); Ítalo Gomes Santana, Rio de Janeiro (BR); Miguel Paredes Quiñones, Campinas (BR)

(21) Appl. No.: 18/600,952

(22) Filed: Mar. 11, 2024

(51) Int. Cl. G06F 17/11

(52) U.S. Cl. CPC G06F 17/11

(57) ABSTRACT

Generating a representative scenario for generating solutions that account for stochastic events in an environment. Historical data is mined to identify events such as stay points and stochastic events. These are used to generate a representative scenario of an environment. A model is used to generate a probability distribution for the stochastic events. An objective function can be generated that accounts for the stochastic events and/or other aspects of the environment such as stay points. An optimization algorithm can generate a solution using the representative scenario that has been incorporated into the objective function.

### FIELD OF THE INVENTION

Embodiments of the present invention generally relate to generating representative scenarios. More particularly, at least some embodiments of the invention relate to systems, hardware, software, computer-readable media, and methods for generating a representative scenario and identifying solutions to real-world problems that are robust to impediments.

### BACKGROUND

Optimization problems are often defined in terms of their difficulty or hardness. For example, optimization problems may exist in environments such as warehouses where there is a need to transport objects from one place to another place (e.g., from shelving to shipping or vice versa). These objects may be transported using robots or forklifts. Determining the optimal routes for the robots and forklifts operating in the warehouse environment is a derivation of an NP-hard optimization problem known as the vehicle routing problem (VRP). In one example, the optimization is to execute tasks (e.g., transporting objects) in a minimum amount of time or distance travelled.

Restrictions may be added to generate special cases of VRPs. Restrictions may be added by changing the objective function of the optimization problem. For example, the optimization problem may be restricted by considering the loading capacity of each vehicle or robot. This becomes a capacitated vehicle routing problem (CVRP). In the context of a warehouse, the VRP is often referred to as a multi-robot (or vehicle) task allocation (MRTA) problem. An MRTA problem is often subject to the heterogeneous capacities/capabilities of the vehicles. Further, the initial positions of the vehicles may vary and may be scattered within the environment.

An MRTA problem may also be subject to other constraints including stochastic processes. These constraints or stochastic processes often appear as impediments (or obstacles) in routes that may block specific areas, fuel efficiency, component lifespan, and the like.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of a warehouse environment;

FIG. 1B discloses aspects of spatial trajectory data;

FIG. 1C discloses aspects of stay points mined from spatial trajectory data;

FIG. 1D discloses aspects of identifying a stay point;

FIG. 2 discloses aspects of generating a representative scenario;

FIG. 3 discloses aspects of generating representative scenarios for optimization problems using characteristic clustering; and

FIG. 4 discloses aspects of a computing device, system, or entity.

### DETAILED DESCRIPTION OF SOME EXAMPLE EMBODIMENTS

Embodiments of the present invention generally relate to generating representative scenarios for use in solving optimization problems such as NP-problems. More particularly, at least some embodiments of the invention relate to systems, hardware, software, computer-readable media, and methods for solving problems using representative scenarios that incorporate or account for statistical elements and/or stochastic processes.

Embodiments of the invention relate to generating representative scenarios using characteristic clustering. Characteristic clustering can be used to adapt an objective problem and generate solutions that account for stochastic processes and other impediments that may occur in an environment. Embodiments of the invention are discussed in the context of generating representative scenarios for various problem types including NP (nondeterministic polynomial time)-hard problems, but are not limited thereto. Embodiments of the invention are further discussed in the context of VRP problems, CVRP problems, and MRTA problems, but are not limited thereto. These types of problems are often combinational in nature and the goal is to identify an optimal combination or a sufficiently optimal combination or solution. More specifically, embodiments of the invention are discussed in the context of a warehouse environment that include different classes of objects including robots, forklifts, and users (humans). The robots and forklifts may operate in an automated manner.

Embodiments of the invention may generate solutions to an optimization problem using a representative scenario that is robust with respect to potential impediments or other events that may arise or occur in the environment. For example, vehicles (e.g., robots and forklifts) operating in a warehouse may be configured to perform tasks including pick-up and delivery tasks. The objective problem in this scenario, in one example, is to route the vehicles in a manner that minimizes time required to perform the tasks, distance travelled, fuel consumption, or the like or combinations thereof.

Embodiments of the invention account for aspects of the stochastic nature or processes present in the family of VPR problems and allow robust solutions to be identified that at least partially account for their stochastic nature. Using a representative scenario allows solutions to account for impediments including stochastic processes or events. Embodiments of the invention generate representative scenarios of an optimization problem using data mining techniques and statistics or probabilities. Embodiments of the invention include a solution as-a-service for entities that manipulate stored data, for logistic domains, for supply chain domains, or the like.

Embodiments of the invention are able to identify impediments (also referred to as obstacles, stochastic events, stochastic processes) that may occur in the context of logistics operations and label these impediments as defined obstacles within the problem context. More specifically, embodiments of the invention may generate a representative scenario that accounts for impediments that may occur randomly in an environment, but can be represented statistically. For example, a warehouse environment may be subject to randomly occurring impediments such as oil spills, boxes left in a vehicle lane or path, a vehicle that brakes unexpectedly, preventative maintenance requirements, tools in a vehicle lane or path, or the like. These types of impediments can impact the routes traveled by vehicles in the environment. Generating solutions, using a representative scenario, that account for these types of impediments is likely to be more efficient overall.

As previously stated, embodiments of the invention are discussed in the context of a warehouse environment and the logistics or optimization problem of routing vehicles to perform tasks including picking up loads and delivering loads.

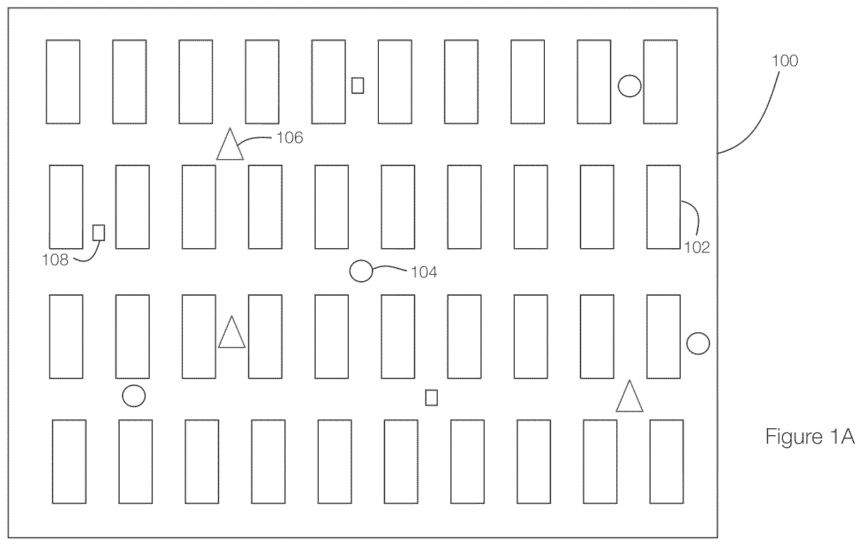

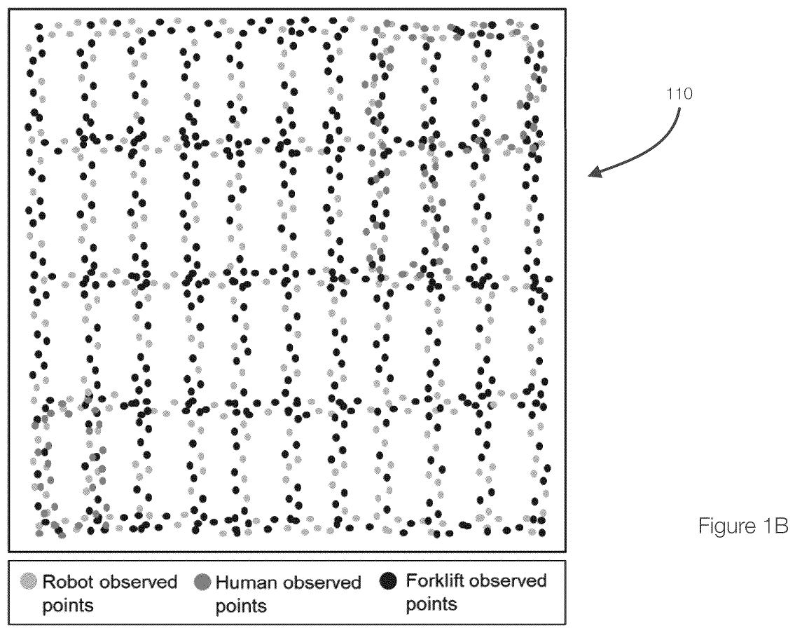

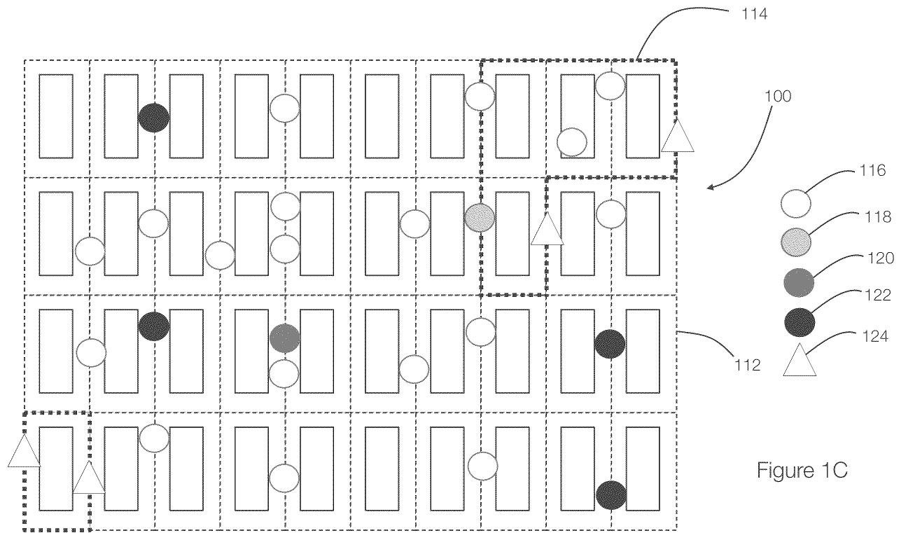

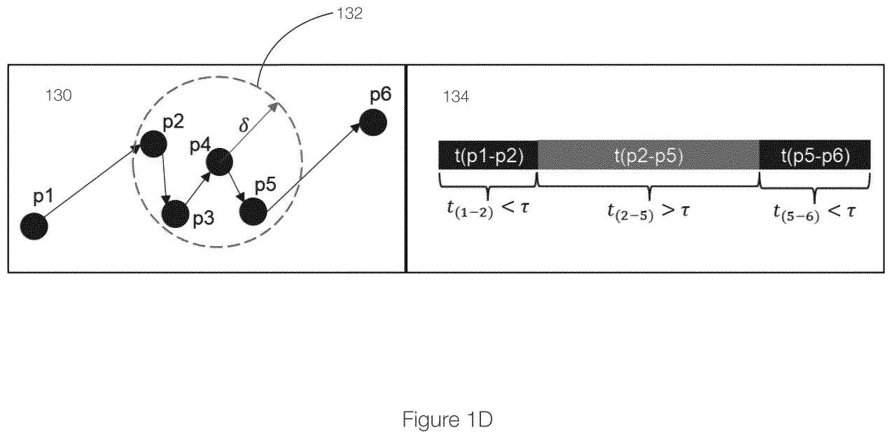

FIG. 1A discloses aspects of a warehouse environment. FIG. 1A illustrates a warehouse 100 that includes shelving or pallet racks, represented by a rack 102. FIG. 1A further illustrates different types of vehicles (and other entities) that may operate in the environment of the warehouse 100. These include, in this example, robots 104, forklifts 106, and users 108.

Over time, the movements, trajectories, and/or positions of the robots 104, forklifts 106, and users 108 may be tracked and stored in a dataset of spatial trajectory data.

FIG. 1B discloses aspects of spatial trajectory data. FIG. 1B illustrates a dataset (D) 110 of spatial trajectory data for each type of object operating or moving in the warehouse environment 100. The dataset 110 may be mined using various data mining techniques to extract relevant information or patterns for a myriad of applications.

For example, the dataset 110 may be mined to determine the time spent at various locations in the environment 100. By way of example, the dataset 110 may be mined to determine the existence or presence of stay points (r). In one example, a stay point represents points where a vehicle or human spend an unusual amount of time. In a warehouse environment 100, stay points may include or be associated with key pallet racks that stores goods that are frequently shipped and thus moved. These key pallet racks may be visited by the vehicles or humans with a higher frequency.

Techniques such as map matching can be used to describe or identify the lanes or paths used by the vehicles and humans in the environment 100. If data exists about the type of object (e.g., type vehicle), the path and/or stay points can be semantically segmented. Other features can be similarly semantically segmented. Further, understanding the type of object may allow different penalizations for certain regions or areas of the environment 100 in the objective function of the optimization algorithm. Thus, FIG. 1B represents the spatial trajectory data that may be collected over time. More specifically, FIG. 1B illustrates locations in the environment at which robots, forklifts, and humans were observed. The dataset 110 may associate metadata with these locations or points such as object type (e.g., human, forklift, robot), velocity, load weight, or the like.

FIG. 1C discloses aspects of stay points mined from spatial trajectory data in the dataset 110. More specifically, each point in FIG. 1C is an element e (e.g., a transaction) of the dataset (D) 110. In this example e is a vector in [symbol] ⁴ with the following features: {x, y, t, class}. In this example, the possible classes are human, robot, and forklift. In this example, x and y are a position or positions and t is a time or timestamp of when the point was measured.

This information allows subsets of the dataset 110 to be created for each class (R(robot), H(human), and F(forklift)). Performing data mining on the dataset 110 and/or the subsets R, H and F allows useful information to be identified regarding a representative scenario or with regard to generating a representative scenario.

FIG. 1C illustrates paths 112 (represented by a dashed line) determined from the dataset 110. Mining the dataset 110 allowed paths 112 that are traversed by robots and forklifts to be identified. (In some examples, the paths may already be known or specified). The lanes or paths 114 (heavier dotted line) are paths that are traversed by robots, forklifts, and humans. More specifically, the paths 112 and 114 may have been found via map matching operations (e.g., Geometric Point-to-Point Matching) to both the dataset 110 and/or to the sub datasets R, H and F. As illustrated in FIG. 1B, humans do not traverse the paths 112 (or traverse much less frequently).

FIG. 1C also illustrates stay points. The stay points 116 represent a stay point for a robot. The stay points 118 represent a stay point for a robot and a human. The stay points 120 represent a stay point for a robot and a forklift. The stay points 122 represent a stay point for a forklift. The stay points 124 represent stay points for a human.

A stay point may be defined in terms of distance and time. For a group of locations or points to quality as a stay point generally require a specific vehicle to be within a certain distance (e.g., within a defined circle) for at least a certain amount of time. The time interval used to define a stay point may vary from one example to the next. Thus, different environments may use different distance and time thresholds. The time interval, used to define a stay interval may be based on multiple factors, such as high traffic around some pallet racks or impediments in the lanes or paths.

FIG. 1D discloses aspects of identifying a stay point when mining the dataset 110. As previously stated, a stay point, by way of example only, may identify a location (or area) where an object spends an unusual amount of time. The amount of time may be unusual, by way of example only, in the context of being different from the time spent at other locations. For example, a forklift removing a pallet from a pallet rack spends more time at that location compared to when the forklift is traveling to the pickup or delivery location. Time spent at specific locations while moving is comparably smaller.

In one example, a heuristic is performed on the dataset to identify a stay point. FIG. 1C illustrates a series of trajectory points 130 (p1, p2, p3, p4, p5, p6) associated with a specific vehicle. In this heuristic, a distance δ and a time interval τ, which are usually predetermined, act as spatiotemporal constraints. In the trajectory points 130, the heuristic may look for a point that clusters a highest number of neighbor points within a circle of radius δ. Next, the heuristic may determine whether these points are visited in a time interval greater than τ. If the cluster of points is valid under these constraints, the region is a stay point.

This example illustrates that the trajectory points p2, p3, p4, and p5 are within a region 132, which is a circle with radius δ. All of these points (p2, p3, p4, p5) are visited in a time interval greater than τ. This is illustrated in the graph 134, which demonstrates the following relationships. First, the trajectory points p1 and p2 were both visited in a time less than the determined time interval (t₍₁₋₂₎<τ). The trajectory points p2-p5 were visited in a time greater than the determined time interval (t₂₋₅>τ). The trajectory points p5 and p6 were visited in a time less than the determined time interval t₅₋₆<τ).

Using the determined distance and the determined time interval, the cluster of trajectory points p2-p5 is determined to be a stay point. Thus, the trajectory points in the dataset 110 (or the sub datasets R, F, and H) can be mined to determine stay points for each class or for class combinations. As illustrated in FIG. 1C, stay points may be determined for each class and/or combinations of classes.

In some examples, other features may be determined such as an average velocity traveled by the objects in each path. Computing other features may be case dependent and may depend on the information present in the dataset 110. By way of example, one aspect of a representative scenario may include identifying stay points. The type of data mined and used in a representative scenario may depend on the problem being solved, the environment or the like. Embodiments of the invention are not limited to stay points, which are discussed by way of example.

More generally, embodiments of the invention perform data mining on a dataset to extract information that may be relevant for solving a problem such as an MRTA problem such that the solution is more robust to real world impediments (or events) by creating a representative scenario.

The dataset (D) 110 may include historical data from geospatial localization of moving objects. This data can be enriched with annotations from several phenomena that may be the cause of some abnormal behaviors. For example, an abnormally large stop may be caused by mechanical problems in a vehicle, an oil spill on the floor of the warehouse, or the like. Obtaining the labels of these events allows probabilistic models to be constructed. These probabilistic models can be used to penalize the objective function when choosing routes that may be subject to these events or phenomena or other impediments.

In one example, a neural network model can be used to approximate a probability density function and classify whether a vehicle will encounter an impediment in a lane or path close to, for example, a maintenance station in the environment. The model may be specific to a route or portion of a path that may be included in a route. Thus, if an impediment statistically occurs at a particular location, routes passing through that location may be modified (e.g., fewer routes may include that particular location).

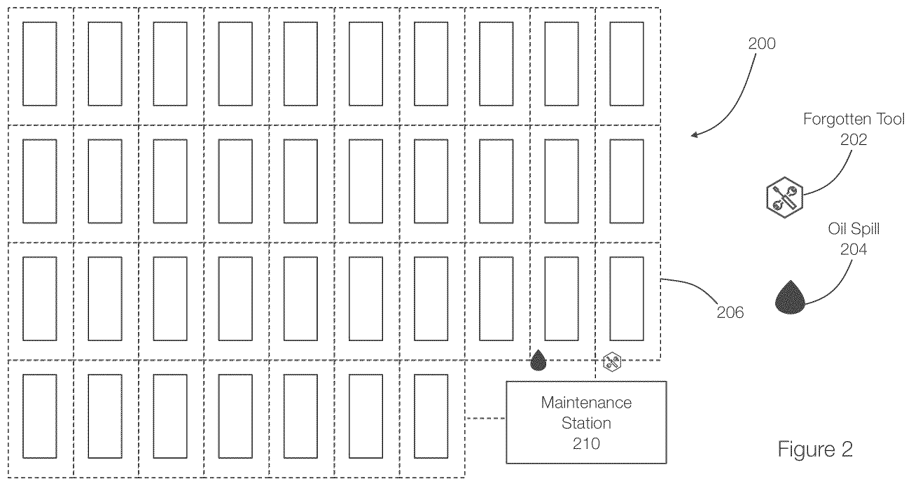

FIG. 2 discloses aspects of generating a representative scenario. FIG. 2 illustrates a warehouse environment 200, which is an example of the warehouse 100. In this example, lanes or paths 206 are illustrated. FIG. 2 also illustrates impediments such as a forgotten tool 202 and an oil spill 204 in a portion of a lane or path near a maintenance station 210.

The impediments 202 and 204 are not always present in the environment 200 and may be transitory in nature (e.g., random) because oil spills are cleaned up and tools are retrieved. However, they do occur from time to time and may impact the logistics associated with controlling or routing vehicles operating in the environment 200. When the dataset 110 has historically labeled data for these impediments, a probabilistic model (M) (e.g., logistic regression, neural network, Bayesian neural network) can be trained to output the probably of paths near to a particular area, region, or the like presenting an impediment during certain times of the day, certain days of the month, or the like.

Identifying stay points may not be suitable for defining or identifying these types of impediments in part because these types of impediments are typically sporadic and transitory. As a result, identifying stay points may be blind to specific phenomena. However, a probabilistic model can infer the likelihood of these impediments occurring using labeled data. This information can be used by the optimization algorithm to avoid unwanted stops and delays that are due to these type of sporadic and transitory impediments.

An example model may be expressed as:

$$M = P ( l \vert x , y , d , b ) . \qquad ( equation 1 )$$

In this example, P is a model (e.g., neural network) fitted to output the probability of a blocked path, at a given vector of features x, y, t, d, b (x and y are the coordinates of the path or location of the impediment or the like, d is a timestamp and b is a number of objects (or assets) in maintenance that day). An output prediction of l=1 indicates that the lane or path is obstructed by the impediment. With this example model, an output of a high probability value indicates that, even if the task is geometrically closer to navigate through a certain path that includes the impediment, the optimization algorithm may choose an alternative path due to the possibility of finding an unwanted impediment. In one example, the data needed to infer how long the asset will be stopped in case of the presence of an impediment may be available and could be used in performing routing operations.

In a typical VRP, an example of canonical objective function can be defined as:

$$J = {\sum }_{i = 0}^{N} {j}_{i} ( x , y ) . \qquad ( equation 2 )$$

Equation 2, however, does not consider the probable impediments or events and other simultaneous actions that are happening during the execution of the programmed tasks. In this example, j receives a pair of coordinates (x, y) that indicate the position of an object that must be picked up and which robot must execute the picking up task. The total cost in the environment is given by the summation of the distance traveled by each robot i (and/or other vehicles) to complete all the assigned tasks.

The objective of the optimization algorithm is then defined as finding the best path or the best subset of coordinates x and y for each robot i that minimizes the total distance traveled by all assets J while executing every task.

As J is parametrized in function of distance, e.g., j=dist(x, y), the distance function is adapted so that the distance function is able to contemplate the additional information of the representative scenario, such as path speed, and/or stay points. Moreover, the probabilistic events of impediments in lanes or paths can also be considered. The unit of the cost function may be changed from distance to time, as set forth in the following functions:

$${t}_{k , k + 1} ( {s}_{k} , {s}_{k + 1} , {\overline{v}}_{k , k + 1} , r ) = \frac{dist ( {s}_{k} , {s}_{k + 1} )}{{\overline{v}}_{k , k + 1}} + < {w}_{r} , \\ r > + ( M > ε ) \times {w}_{o} . \qquad ( equation 3 )$$

In this equation (3), time t is used with the information about the representative scenario C to compose a time-dependent cost function. The first term of the equation calculates the time to leave the place of task k and move to the task k+1 where v̅_{k,k+1} is the average velocity of the path between those two points and the distance dist (sₖ, sₖ₊₁) is a measure of distance (e.g., Euclidean or Manhattan distances) between these two tasks. The second term is the inner product between a binary vector r containing ones in the appearance of stay points in the path from sₖ to sₖ₊₁, and wᵣ, which is vector where each element is a time delay (i.e., a penalization in time units) attributed to the passage in each stay point. The last term is an indicator function that outputs one if the prediction of path obstruction or impediment between sₖ and sₖ₊₁ is greater than ε (which is an arbitrary threshold, e.g., 0.5). This prediction is then multiplied by the weight in time units attributed to that impediment or obstacle wₒ. The summation of all those terms returns the total time spent to travel from point sₖ to sₖ₊₁. Then, to compose a full objective function to all tasks and robots, all the time spent to complete all tasks is summed as follows:

$$T {\sum }_{i = 0}^{N} {\sum }_{k = 0}^{K - 1} {t}_{k} ( {s}_{k} , {s}_{k + 1} , {\overline{v}}_{k , k + 1} , r ) . \qquad ( equation 4 )$$

In this form, the newly developed objective function can incorporate all the information obtained from data mining the dataset 110 and the statistical analysis applied to the mined data. This example of integrating the dataset or mined data into the objective function is presented by way of example only. In another example, a distance metric could be used. More specifically, the usual distance metric may be altered to add a quantity that represents the time addition of choosing specific paths. This would in a sense artificially increase the distance of paths given their lane velocity, obstructions and stay points.

Once a representative scenario has been incorporated into the objective function, optimization algorithms, such as Done-CPTA and nCar, may be used to output a solution or solutions that accounts for stochastic impediments or the like. Aspects of Done-CPTA and nCar may be found at, respectively, J. R. D. M. P. J. T. C. Geroge S. Oliveira, “Efficient Task Allocation in Smart Warehouses with Multi-delivery Stations and Heterogeneous Robots,” arXiv, 2022, and N. v. H. J. G. a. M. W. Wouter Kook, “Deep Policy Dynamic Programming for Vehicle Routing Problems,” arxiv, 2021, which are incorporated herein by reference. Thus:

$${p}^{*} = arg min ( J ) . \qquad ( equation 5 )$$

The returned solution p* obtained in embodiments of the invention results in paths or routes are more robust to stochastic events in the context of historical geospatial data.

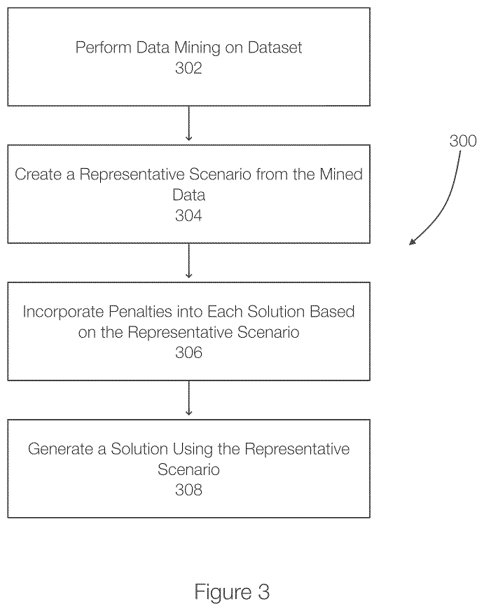

FIG. 3 discloses aspects of generating representative scenarios for optimization problems using characteristic clustering. Steps or acts of a method 300 may be performed together or separately. Further, the method 300 may include elements that may be repeated, for example as additional data is collected and stored in the dataset.

In the method 300, a dataset is mined 302 to gather data related to an optimization problem. In the context of a vehicle routing problem, a dataset that includes spatial trajectory data, which may be labeled, may be mined to gather data for generating a representative scenario. This may include data such as the frequency with which a path is obstructed or impeded, how long the impediment or obstruction lasted, a cause of the impediments, a nature of the impediment, stay points, average path velocities, or the like.

The mined data may be used or processed to create or generate 304 a representative scenario. In one example, a representative scenario for a warehouse environment may include stay points and impediments or other clusters. Once the stay points and impediments are identified, along with labels, a probabilistic model can be generated. In one example, the model may determine the probability of a lane or path being blocked by an impediment. Thus, the mined data allows the model to generate a probability regarding the location of potential impediments or a probability regarding a path that passes through the potential impediment. The output of the model may be incorporated into an objective function.

Next, penalties are incorporated 306 into objective function to reflect the impact of stay points, impediments and/or other stochastic events. This may include changing a cost unit of a cost function from distance to time. More specifically, the objective function is adapted, based on the generated representative scenario, to account for the likelihood of a path being impeded, stay points, and/or the like.

Next, a solution is generated 308 using the adapted objective function, which accounts for the probabilities associated with impediments, stay points and the like represented in the representative scenario. The operations required to execute the solution may then be implemented and performed in the environment. The vehicles may be assigned tasks/paths according to the solution.

It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In general, embodiments of the invention may be implemented in connection with systems, software, and components, that individually and/or collectively implement, and/or cause the implementation of, generating solutions for optimization problems, accounting for stochastic processes or events in generating an objective function, mining data sets, generating representative scenarios, or the like or combinations thereof. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Example embodiments of the invention are applicable to any system capable of storing, handling, processing, and the like, various types of objects, in analog, digital, or other form.

It is noted that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: mining a dataset of historical data related to an environment to obtain mined data, creating a representative scenario from the mined data, wherein the representative scenario includes impediments, wherein at least some of the impediments are stochastic impediments, incorporating the representative scenario into an objective function to incorporate penalties for the impediments, and generating a solution using the objective function, wherein the solution accounts for probabilities of the stochastic impediments occurring in the environment.

Embodiment 2. The method of embodiment 1, wherein the historical data comprises spatial trajectory data for at least vehicles operating in a warehouse.

Embodiment 3. The method of embodiment 1 and/or 2, wherein the vehicles include robots and forklifts configured to perform tasks including pick-up and delivery tasks.

Embodiment 4. The method of embodiment 1, 2, and/or 3, wherein paths for the vehicles are determined from the mined data, wherein stay points for the vehicles are determined from the mined data, wherein stay points are defined by clusters of points that satisfy a distance requirement and a time requirement.

Embodiment 5. The method of embodiment 1, 2, 3, and/or 4, wherein the distance requirement requires the points in the cluster to be located in a circle whose radius is the distance requirement and wherein the time requirement requires time spent to be greater than the time requirement.

Embodiment 6. The method of embodiment 1, 2, 3, 4, and/or 5, further comprising generating a model to generate the probabilities of the stochastic impediments, wherein the model is based on features including coordinates of the path or of the impediment, a timestamp, and a number of assets in maintenance.

Embodiment 7. The method of embodiment 1, 2, 3, 4, 5, and/or 6, further comprising a cost function from distance to time such that the cost function accounts for probabilistic events of impediments in the paths.

Embodiment 8. The method of embodiment 1, 2, 3, 4, 5, 6, and/or 7, wherein the cost function is:

$${t}_{k , k + 1} ( {s}_{k} , {s}_{k + 1} , {\overline{v}}_{k , k + 1} , r ) = \frac{dist ( {s}_{k} , {s}_{k + 1} )}{{\overline{v}}_{k , k + 1}} + < {w}_{r} , r > + ( M > ε ) \times {w}_{o} ,$$

wherein a first term

$$( \frac{dist ( {s}_{k} , {s}_{k + 1} )}{{\overline{v}}_{k , k + 1}} )$$

determines a time to leave a first location of task k and move to a second location of task k+1 using an average velocity of a path between the first location and the second location, a second term (<wᵣ, r>) is an inner product between a binary vector containing stay points in the path from the first location to the second location, and a vector that includes a penalization attributed to each stay point, and an indicator function ( [symbol] (M>ε)×wₒ) whose output is a prediction of an impediment occurring in the path between the first location and the second location, wherein the cost function generates a total time to complete the task.

Embodiment 9. The method of embodiment 1, 2, 3, 4, 5, 5, 6, 7, and/or 8, wherein a total time for all tasks and all robots is TΣi=0^{N}Σₖ₌₀^{K-1}tₖ(sₖ, sₖ₊₁, v̅_{k,k+1}, r).

Embodiment 10. The method of embodiment 1, 2, 3, 4, 5, 6, 7, 8, and/or 9, wherein the solution is configured accounts for stochastic events using stochastic events derived from the dataset of historical data.

Embodiment 11 A system, comprising hardware and/or software, operable to perform any of the operations, methods, or processes, or any portion of any of these, disclosed herein.

Embodiment 12 A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, agent, client, or service may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

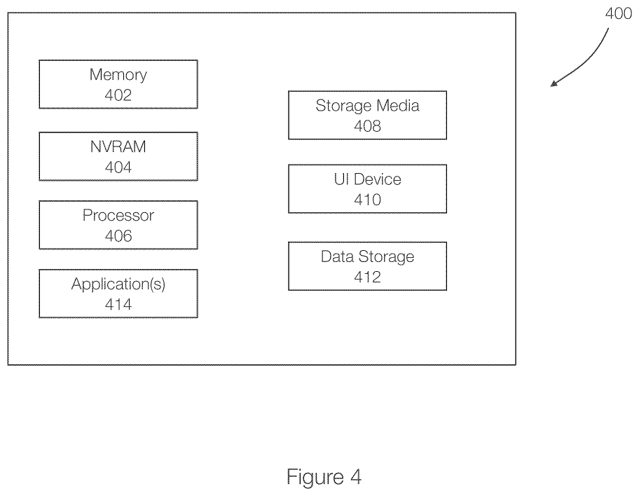

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
mining a dataset of historical data related to an environment to obtain mined data;
creating a representative scenario from the mined data, wherein the representative scenario includes impediments, wherein at least some of the impediments are stochastic impediments;
incorporating the representative scenario into an objective function to incorporate penalties for the impediments; and
generating a solution using the objective function, wherein the solution accounts for probabilities of the stochastic impediments occurring in the environment.

2. The method of claim 1, wherein the historical data comprises spatial trajectory data for at least vehicles operating in a warehouse.

3. The method of claim 2, wherein the vehicles include robots and forklifts configured to perform tasks including pick-up and delivery tasks.

4. The method of claim 1, wherein paths for the vehicles are determined from the mined data, wherein stay points for the vehicles are determined from the mined data, wherein stay points are defined by clusters of points that satisfy a distance requirement and a time requirement.

5. The method of claim 4, wherein the distance requirement requires the points in the cluster to be located in a circle whose radius is the distance requirement and wherein the time requirement requires time spent to be greater than the time requirement.

6. The method of claim 1, further comprising generating a model to generate the probabilities of the stochastic impediments, wherein the model is based on features including coordinates of the path or of the impediment, a timestamp, and a number of assets in maintenance.

7. The method of claim 1, further comprising a cost function from distance to time such that the cost function accounts for probabilistic events of impediments in the paths.

8. The method of claim 7, wherein the cost function is:
$${t}_{k , k + 1} ( {s}_{k} , {s}_{k + 1} , {\overline{v}}_{k , k + 1} , r ) = \frac{dist ( {s}_{k} , {s}_{k + 1} )}{{\overline{v}}_{k , k + 1}} + < {w}_{r} , r > + ( M > ε ) \times {w}_{o} ,$$
wherein a first term
$$( \frac{dist ( {s}_{k} , {s}_{k + 1} )}{{\overline{v}}_{k , k + 1}} )$$
determines a time to leave a first location of task k and move to a second location of task k+1 using an average velocity of a path between the first location and the second location, a second term (<wᵣ, r>) is an inner product between a binary vector containing stay points in the path from the first location to the second location, and a vector that includes a penalization attributed to each stay point, and an indicator function ( [symbol] (M>ε)×wₒ) whose output is a prediction of an impediment occurring in the path between the first location and the second location, wherein the cost function generates a total time to complete the task.

9. The method of claim 8, wherein a total time for all tasks and all robots is TΣᵢ₌₀^{N}Σₖ₌₀^{K-1}tₖ(sₖ, sₖ₊₁, v̅_{k,k+1}, r).

10. The method of claim 9, wherein the solution accounts for stochastic events using stochastic events derived from the dataset of historical data.

11. A non-transitory storage medium having stored therein instructions that are executable by one or more hardware processors to perform operations comprising:
mining a dataset of historical data related to an environment to obtain mined data;
creating a representative scenario from the mined data, wherein the representative scenario includes impediments, wherein at least some of the impediments are stochastic impediments;
incorporating the representative scenario into an objective function to incorporate penalties for the impediments; and
generating a solution using the objective function, wherein the solution accounts for probabilities of the stochastic impediments occurring in the environment.

12. The non-transitory storage medium of claim 11, wherein the historical data comprises spatial trajectory data for at least vehicles operating in a warehouse.

13. The non-transitory storage medium of claim 12, wherein the vehicles include robots and forklifts configured to perform tasks including pick-up and delivery tasks.

14. The non-transitory storage medium of claim 11, wherein paths for the vehicles are determined from the mined data, wherein stay points for the vehicles are determined from the mined data, wherein stay points are defined by clusters of points that satisfy a distance requirement and a time requirement.

15. The non-transitory storage medium of claim 14, wherein the distance requirement requires the points in the cluster to be located in a circle whose radius is the distance requirement and wherein the time requirement requires time spent to be greater than the time requirement.

16. The non-transitory storage medium of claim 11, further comprising generating a model to generate the probabilities of the stochastic impediments, wherein the model is based on features including coordinates of the path or of the impediment, a timestamp, and a number of assets in maintenance.

17. The non-transitory storage medium of claim 11, further comprising a cost function from distance to time such that the cost function accounts for probabilistic events of impediments in the paths.

18. The non-transitory storage medium of claim 17, wherein the cost function is:
$${t}_{k , k + 1} ( {s}_{k} , {s}_{k + 1} , {\overline{v}}_{k , k + 1} , r ) = \frac{dist ( {s}_{k} , {s}_{k + 1} )}{{\overline{v}}_{k , k + 1}} + < {w}_{r} , r > + ( M > ε ) \times {w}_{o} ,$$
wherein a first term
$$( \frac{dist ( {s}_{k} , {s}_{k + 1} )}{{\overline{v}}_{k , k + 1}} )$$
determines a time to leave a first location of task k and move to a second location of task k+1 using an average velocity of a path between the first location and the second location, a second term (<wᵣ, r>) is an inner product between a binary vector containing stay points in the path from the first location to the second location, and a vector that includes a penalization attributed to each stay point, and an indicator function ( [symbol] (M>ε)×wₒ) whose output is a prediction of an impediment occurring in the path between the first location and the second location, wherein the cost function generates a total time to complete the task.

19. The non-transitory storage medium of claim 18, wherein a total time for all tasks and all robots is TΣᵢ₌₀^{N}Σₖ₌₀^{K-1}tₖ(sₖ, sₖ₊₁, v̅_{k,k+1}, r).

20. The non-transitory storage medium of claim 19, wherein the solution accounts for stochastic events using stochastic events derived from the dataset of historical data.
